(19) United States
(12) Patent Application Publication
(10) Pub. No.: US 2012/0301610 A1
(43) Pub. Date: Nov. 29, 2012

(54) METHOD OF PRODUCING GLASS PREFORM AND APPARATUS FOR PRODUCING THE SAME

(75) Inventors: Keiichi Aiso, Tokyo (JP); Tetsuro Wada, Tokyo (JP); Shinji Asao, Tokyo (JP); Nobuaki Orita, Tokyo (JP); Takeshi Yagi, Tokyo (JP)

(73) Assignee: FURUKAWA ELECTRIC CO., LTD., Tokyo (JP)

(21) Appl. No.: 13/525,572

(22) Filed: Jun. 18, 2012

Related U.S. Application Data
(63) Continuation of application No. PCT/JP11/60164, filed on Apr. 26, 2011.

(30) Foreign Application Priority Data
Apr. 26, 2010 (JP) 2010-101280

(51) Int. Cl. B05D 1/12; B05C 19/04

(52) U.S. Cl. 427/180; 118/608

(57) ABSTRACT

A method of producing a glass preform by depositing silica powder that contains silica particles on a starting material includes a transferring step, a disaggregating step, and a depositing step. The transferring step includes transferring the silica powder. The disaggregating step includes disaggregating and dispersing agglomerates of the silica particles contained in the silica powder while being transferred in the transferring step. The depositing step includes depositing the silica powder, which is transferred and is obtained by disaggregating and dispersing the agglomerates of the silica particles, on the starting material.

### CROSS-REFERENCE TO RELATED APPLICATIONS

This application is a continuation of PCT international Application No. PCT/JP2011/060164 filed on Apr. 26, 2011 which claims the benefit of priority from Japanese Patent Application No. 2010-101280 filed on Apr. 26, 2010, the entire contents of which are incorporated herein by reference.

### BACKGROUND

1. Field

The present disclosure relates to a method of producing a glass preform and an apparatus for producing a glass preform.

2. Description of the Related Art

A typical silica glass-based optical fiber is produced by drawing an optical fiber preform made of silica glass. Widely used methods of producing an optical fiber preform include VAD (Vapor-phase Axial Deposition), OVD (Outside Vapor-phase Deposition), MCVD (Modified Chemical Vapor Deposition), and plasma methods. With these producing methods, silicon tetrachloride is generally used as a raw material for the silica glass. The methods involve hydrolysing or oxidizing silicon tetrachloride gas in a flame to synthesize silica microparticles and then depositing the silica microparticles on a starting material that functions as a substrate, thereby producing a porous glass preform. During sintering, which is performed later, the porous glass preform is transformed into transparent glass and then a transparent optical fiber preform is produced, which is ready for drawing.

Because silicon tetrachloride is a highly corrosive material, it is difficult to maintain and manage equipment used in the material-feeding system. Moreover, during hydrolysing, hydrogen chloride is generated and during oxidizing, chlorine is generated; therefore, treating these gases places an extra work load on the equipment that performs the exhaust gas and effluent treatment processes. Therefore, a method of producing a glass preform that use silica (silicon dioxide) powder as a raw material instead of silicon tetrachloride have been discussed (see Japanese Patent Application Laid-open No. S61-077631, Japanese Patent Application Laid-open No. 2004-300006, Japanese Patent Application Laid-open No. 2005-255502, International Publication Pamphlet No. WO2004/083139, Japanese Patent Application Laid-open No. 2001-294440, and Japanese Patent Application Laid-open No. 2003-020243). When silica powder is used as a raw material, because no silicon tetrachloride is used, neither hydrogen chloride nor chlorine is generated; therefore, the above difficulties and work loads will be reduced.

When silica powder is used as a raw material, a porous glass preform is produced by, for example, spraying silica powder toward a starting material with a flame, thereby adhering and depositing the silica powder thereon. Silica powder used in this way contains, for example, silica particles (fumed silica) synthesized by a hydrolysis reaction in the flame. Because the concentrations of impurities in fumed silica are low, fumed silica is suitable as a raw material for a glass preform for producing an optical fiber that requires high purity.

When silica powder is used that contains small particles, like fumed silica, with the particle diameter from 5 nm to 50 nm, there is the possibility of the occurrence of protruding deposition (bumps) on a deposition surface and a decrease in the smoothness of the deposition surface. Bumps on a glass preform and a decrease in the smoothness of the deposition surface are factors that cause, when an optical fiber is produced by using such a glass preform, degradation of optical fiber property, such as a change in the outer diameter of the optical fiber and a cladding portion that is not perfectly round.

The inventors have realized that there is a need to provide a method of producing a glass preform that has a smooth surface and an apparatus for producing the glass preform.

### SUMMARY

In accordance with some embodiments, a method of producing a glass preform by depositing silica powder that contains silica particles on a starting material is presented. In some embodiments, the method of producing a glass preform includes a transferring step, a disaggregating step, and a depositing step. The transferring step includes transferring the silica powder. The disaggregating step includes disaggregating and dispersing agglomerates of the silica particles contained in the silica powder while being transferred in the transferring step. The depositing step includes depositing the silica powder, which is transferred and is obtained by disaggregating and dispersing the agglomerates of the silica particles, on the starting material.

Moreover, in accordance with some embodiments, another method of producing a glass preform by depositing silica powder that contains silica particles on a starting material is presented. In some embodiments, the method of producing a glass preform includes a transferring step, a classifying step, and a depositing step. The transferring step includes transferring the silica powder. The classifying step includes classifying agglomerates of the silica particles contained in the silica powder while being transferred in the transferring step. The depositing step includes depositing the silica powder, which is transferred and is obtained by classifying the agglomerates of the silica particles, on the starting material.

Furthermore, in accordance with some embodiments, an apparatus for producing a glass preform by depositing silica powder that contains silica particles on a starting material is presented. In some embodiments, the apparatus for producing a glass preform includes a transferring device, a disaggregating device, and a depositing device. The transferring device transfers the silica powder. The disaggregating device is connected to the transferring device and disaggregates and disperses agglomerates of the silica particles contained in the silica powder while being transferred by the transferring device. The depositing device is connected to the disaggregating device and deposits silica powder, which is transferred and is obtained by disaggregating and dispersing the agglomerates of the silica particles, on the starting material.

Additionally, in accordance with some embodiments, another apparatus for producing a glass preform by depositing silica powder that contains silica particles on a starting material is presented. In some embodiments, the apparatus for producing a glass preform includes a transferring device, a classifying device, and a depositing device. The transferring device transfers the silica powder. The classifying device is connected to the transferring device and classifies agglomerates of the silica particles contained in the silica powder while being transferred by the transferring device. The depositing device is connected to the classifying device and deposits the silica powder, which is transferred and obtained by classifying the agglomerates of the silica particles, on the starting material.

### BRIEF DESCRIPTION OF THE DRAWINGS

FIG. 1 is a schematic diagram of an apparatus for producing a glass preform according to the first embodiment.

FIG. 2 is a schematic diagram of another example of the disaggregating device.

FIG. 3 is a schematic diagram of another example of the disaggregating device.

FIG. 4 is a schematic diagram of another example of the depositing device.

FIG. 5 is a schematic diagram of an apparatus for producing a glass preform according to the second embodiment.

FIG. 6 is a schematic diagram of another example of the classifying device.

FIG. 7 is a schematic diagram of a configuration that is made, based on the apparatus for producing the glass preform illustrated in FIG. 1, by replacing the disaggregating device with the classifying device illustrated in FIG. 5.

### DETAILED DESCRIPTION

Exemplary embodiments of a method of producing a glass preform and an apparatus for producing a glass preform according to the present invention will be explained in detail below with reference to the accompanying drawings. It is noted that the present invention is not limited to the following embodiments.

### First Embodiment

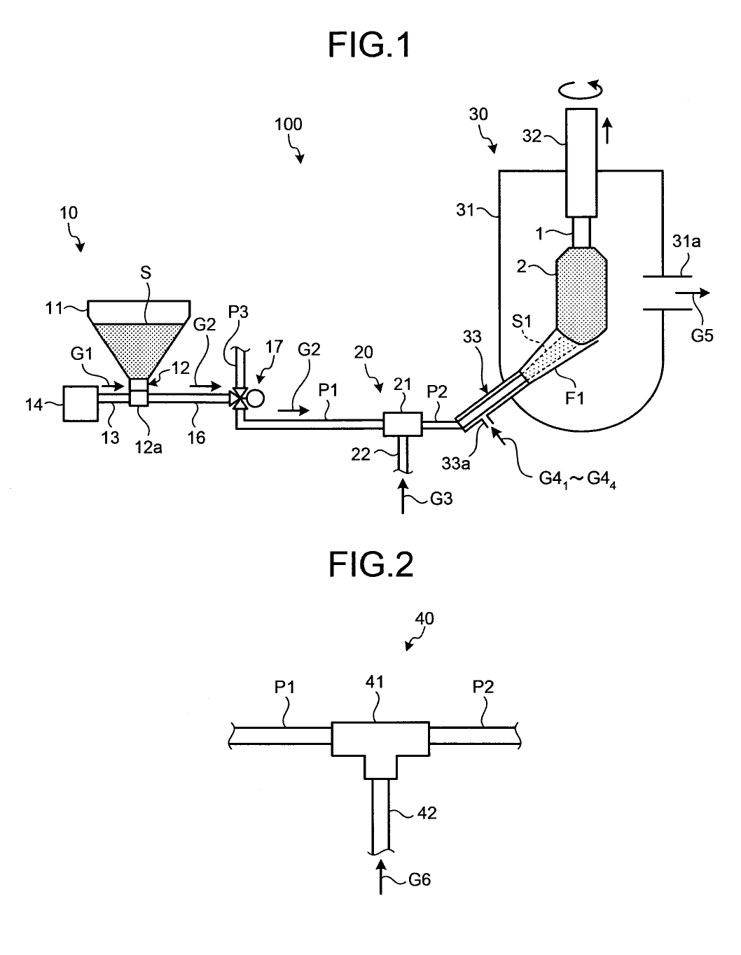

FIG. 1 is a schematic diagram of an apparatus for producing a glass preform according to a first embodiment. As illustrated in FIG. 1, a producing apparatus 100 includes a transferring device 10, a disaggregating device 20 that is connected to the transferring device 10 via a transfer tube P1, a depositing device 30 that is connected to the disaggregating device 20 via a transfer tube P2.

First of all, the transferring device 10 will be explained. The transferring device 10 includes a hopper 11 that stores therein silica powder S, a powder volumetric feeding device 12 that is connected to the hopper 11 and that includes a transferring unit 12a, a carrier-gas feeding device 14 that is connected to the transferring unit 12a of the powder volumetric feeding device 12 via a gas feed tube 13, and a three-way valve 17 that is connected to the transferring unit 12a of the powder volumetric feeding device 12 via a transfer tube 16. The three-way valve 17 is connected to the transfer tube 16, the transfer tube P1, and a vent tube P3 that is connected to a vent, which is not illustrated.

As the powder volumetric feeding device 12, for example, volumetric feeding devices are available, such as a powder pump, a table feeder, and a screw feeder. If a powder pump is used, after the silica powder S in the hopper 11 is fluidized, the silica powder S is pumped out to the transferring unit 12a. Alternatively, if the powder volumetric feeding device 12 is a table feeder, a screw feeder, or the like, it cuts the silica powder S out from the hopper 11 and feeds the silica powder S to the transferring unit 12a.

As the silica powder S, fumed silica powder is available, such as AEROSIL (registered trademark) powder produced by Evonik Degussa (or Nippon Aerosil Co., Ltd.), REOLOSIL (registered trademark) produced by Tokuyama Corporation, and HDK (registered trademark) produced by Wacker Chemie AG. Fumed silica is, generally, synthetic silica particle that is produced using silicon tetrachloride as a raw material by a hydrolysis reaction in a flame, and the impurity concentration of the fumed silica is low. Therefore, fumed silica is suitable as a raw material for a glass preform of an optical fiber that requires a high purity. The average primary particle diameter of fumed silica is extremely small or about 7 nm to 50 nm. The specific surface area, which depends on the particle diameter, is about 50 m²/g to 400 m²/g.

The carrier-gas feeding device 14 feeds a carrier gas G1. The carrier gas G1 preferably contains at least one of hydrogen, helium, and oxygen.

Then, the disaggregating device 20 will be explained. The disaggregating device 20 includes a disaggregating unit 21 that is connected to both the transfer tubes P1 and P2, and a gas feed tube 22 that feeds a disaggregation/dispersion gas G3 into the disaggregating unit 21. The disaggregation/dispersion gas G3 preferably contains at least one of hydrogen, helium, and oxygen.

Then, the depositing device 30 will be explained. The depositing device 30 of the first embodiment has the same configuration as that of a depositing device that produces a glass preform using a VAD method. More particularly, the depositing device 30 includes a reaction chamber 31 that has an exhaust outlet 31a; a lifting mechanism 32 that supports a starting material 1 and lifts it up, while rotating the starting material 1; and a multi-tube burner 33 that is used to deposit the silica powder S on the starting material 1. The multi-tube burner 33 is five layered. A center portion, which is the first layer, is connected to the transfer tube P2. The second layer is an argon gas (burner gas G4₁) feed path, the third layer is a hydrogen gas (burner gas G4₂) feed path, the fourth layer is an argon gas (burner gas G4₃) feed path, and the fifth layer is an oxygen gas (burner gas G4₄) feed path. The second, the third, the fourth, and the fifth layers are connected to a gas feed opening 33a to feed the respective burner gases G4₁ to G4₄. The gas feed opening 33a can feed the burner gases G4₁ to G4₄ separately to the second, the third, the fourth, and the fifth layers, respectively. The starting material 1 is, for example, a rod made of high-purity silica glass.

Then, a method of producing a glass preform according to the present embodiment will be explained using the producing apparatus 100.

Firstly, in the transferring device 10, the powder volumetric feeding device 12 feeds the silica powder S from the hopper 11 to the transferring unit 12a. The carrier-gas feeding device 14 feeds the carrier gas G1 to the transferring unit 12a via the gas feed tube 13 and then transfers a silica-powder-containing carrier gas G2, which contains the silica powder S that is fed to the transferring unit 12a, to the three-way valve 17 via the transfer tube 16. The silica-powder-containing carrier gas G2 is sent to the transfer tube P1 by a switching operation of the three-way valve 17. The transfer tube P1 transfers the silica-powder-containing carrier gas G2 to the disaggregating device 20. When the silica-powder-containing carrier gas G2 is not sent to the transfer tube P1, by a switching operation of the three-way valve 17, the silica-powder-containing carrier gas G2 is discharged from a vent, which is not illustrated, via the vent tube P3.

When any of the above-listed volumetric feeding devices is used as the powder volumetric feeding device 12, the amount of the silica powder S that is fed to the transferring unit 12a is controlled by adjusting the silica-powder discharge rate of the volumetric feeding device. Therefore, the silica-powder discharge rate and the flow rate of the carrier gas G1 are separately controllable. Accordingly, free and easy adjustment is enabled of both the concentration of the silica powder S dispersed in the silica-powder-containing carrier gas G2 and the amount of the transferred silica powder S.

If the silica powder S contains fumed silica particles that have a large specific surface area about 50 m²/g to 400 m²/g, it generally has a high cohesive property; therefore, primary particles are likely to aggregate together and an agglomerate of large-diameter particle is formed. As it is known, agglomerates are categorized into a primary agglomerate (Aggregate), which is formed with primary particles fusion bonded together by heat or chemically bonded together, and a secondary agglomerate (Agglomerate), which is formed with the primary agglomerates physically agglutinated. It is generally known that silica powder is present in a gas or in a liquid in the form of secondary agglomerates or primary agglomerates rather than primary particles.

For evaluation by the inventors of the present invention about the form of silica powder in the carrier gas when it is transferred with the carrier gas, for example, fumed silica that has an average primary particle diameter of 7 nm is transferred through a transfer tube with an air that functions as the carrier gas. The particle size distribution during transfer is measured by using an on-line particle-size distribution measuring device. From the measured particle size distribution curve, a particle diameter that corresponds to 50% of the accumulated distribution curve (median size) is calculated: the result is 17.5 μm. It is assumed from this result that most fumed silica particles are present in the carrier gas in the form of primary agglomerates or secondary agglomerates.

Therefore, it is assumed that the silica powder S is present in the silica-powder-containing carrier gas G2 in the form of primary agglomerates or secondary agglomerates. Therefore, in the present embodiment, the disaggregating device 20 sprays the disaggregation/dispersion gas G3 to the silica-powder-containing carrier gas G2 transferred from the transfer tube P1 in the disaggregating unit 21, thereby disaggregating and dispersing agglomerates of the silica powder S by interparticle collisions and a shear force caused by the flow of the disaggregation/dispersion gas G3. With this configuration, agglomerates of the silica powder S present in the silica-powder-containing carrier gas G2 during transfer are disaggregated and dispersed and the agglomeration level of agglomerates is reduced. The disaggregation/dispersion level of agglomerates is adjustable by using, for example, the flow rate of the disaggregation/dispersion gas G3 and the structure of the disaggregating unit 21. For example, when the flow rate of the disaggregation/dispersion gas G3 is increased, because interparticle collisions and collisions of particles against the inner wall of the tube occur more frequently, the agglomeration level of agglomerates is further reduced. Moreover, if the disaggregating unit 21 has a multistage structure, agglomerates are disaggregated more likely. Moreover, if a constricted part is provided to the disaggregating unit 21 to drastically change the air flow, agglomerates are disaggregated more likely. The disaggregation/dispersion level is preferably adjusted to disaggregate secondary agglomerates to the particle diameter as large as primary agglomerates.

Then, the transfer tube P2 transfers the silica-powder-containing carrier gas G2 that contains the reduced-assembly-level silica powder S to the depositing device 30. In the depositing device 30, the silica-powder-containing carrier gas G2 is fed from the transfer tube P2 to the first layer of the multi-tube burner 33; the burner gases G4₁ to G4₄ is respectively fed from the gas feed opening 33a to the second, the third, the fourth, and the fifth layers. The multi-tube burner 33 then sprays the silica powder S1 contained in the silica-powder-containing carrier gas G2 toward the starting material 1 that is rotated and lifted by the lifting mechanism 32 with a burner flame F1, thereby adhering and depositing the silica powder on the surface of the starting material 1.

If the sprayed silica powder is dispersed, mostly, in the form of primary agglomerates or secondary agglomerates, fusion bonding of agglomerates or fusion and densification of an agglomerate occur in a high temperature portion of the burner flame. As a result, giant particles, which have a diameter several orders larger than the diameter of primary particles, are generated. If such giant particles are generated in the burner flame, when the silica powder is deposited on a starting material, problems occur, such as the occurrence of bumps on the deposition surface and a decrease in the flatness of the deposition surface.

In contrast, because agglomerates of the silica powder S1 of the present embodiment are disaggregated and dispersed by the disaggregating device 20 and the number of agglomerates and the agglomeration level are reduced, the diameter of fumed silica particles of the silica powder S1 fusion bonded in a high temperature portion of the burner flame F1 is also reduced. As a result, deposition of fumed silica particles on the surface of the starting material 1 in the form of giant particles is prevented. Therefore, the occurrence of bumps on the deposition surface and a decrease in the smoothness of the deposition surface are prevented and a porous glass preform 2 that has a smooth deposition surface can be produced.

Because the carrier gas and the unused silica powder S1 are discharged from the exhaust outlet 31a of the reaction chamber 31 as an exhaust gas G5, the inside of the reaction chamber 31 is maintained in a state appropriate for deposition of the silica powder S1.

As described above, with the producing method and the producing apparatus of the first embodiment, the occurrence of bumps of the silica powder S1 on the deposition surface and a decrease in the smoothness of the deposition surface are prevented; therefore, the glass preform 2 that has a smooth deposition surface is produced.

The transferring device 10 can be configured, in the same manner as disclosed in International Publication Pamphlet No. WO2004/083139, to fluidize silica powder in a tank by feeding a carrier gas via a mesh that is arranged in a lower part of the tank that contains the silica powder and then transfer the carrier gas containing the silica powder. Alternatively, the transferring device 10 can be configured to fluidize silica powder in the tank in the same manner, and then transfer the carrier gas containing the silica powder by sucking the fluidized silica powder and the carrier gas by a negative pressure generating unit. When the above configurations are used, the silica-powder discharge rate is controlled only by adjusting the flow rate of the carrier gas or the flow rate of a negative pressure generation gas that is fed to the negative pressure generating unit; therefore, the silica-powder discharge rate and the carrier-gas flow rate are not controlled separately and they are in a proportional relation.

The configuration of the disaggregating device is not limited to the configuration of the above embodiment. FIG. 2 is a schematic diagram of another example of the disaggregating device. As illustrated in FIG. 2, a disaggregating device 40 is an ejector that includes an ejector main body 41 that is connected to the transfer tubes P1 and P2 and a gas feed tube 42 that feeds an ejector gas G6 to the ejector main body 41. As it will be described later, the ejector gas G6 preferably contains at least one of hydrogen, helium, and oxygen.

The disaggregating device 40 can disaggregate and disperse agglomerates by collisions between particles, collisions of particles against the wall inside the ejector main body 41 or the wall inside the transfer tube P2, and a shear force exerted on agglomerated particles caused by the ejector gas G6 and a suction force generated thereby. Moreover, the disaggregating device 40 can control the dispersibility of particles by changing the flow rate of the ejector gas G6 that is fed to the ejector main body 41. The ejector main body 41 can be configured to discretely or continually change the gap of an ejector unit inside. As the disaggregating device, a device is available that uses a venturi, an orifice, and coil formed by spirally winding the transfer tube and the like which can disaggregate and disperse agglomerates by an air flow in the same manner as the ejector.

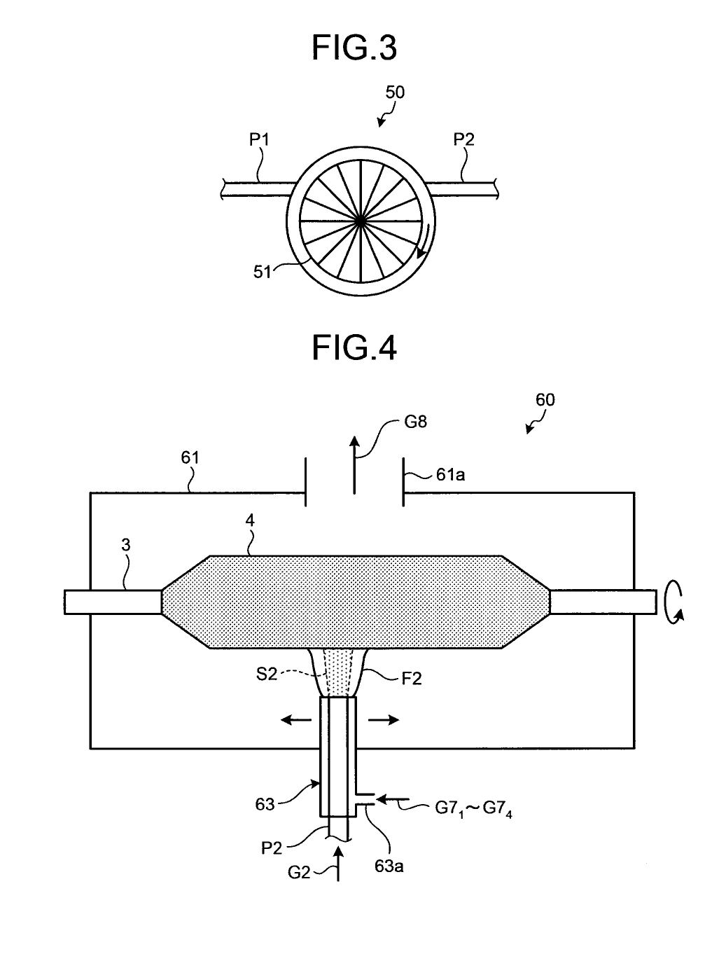

FIG. 3 is a schematic diagram of another example of the disaggregating device. A disaggregating device 50 includes an impeller 51. The disaggregating device 50 performs disaggregation/dispersion by rotating the impeller 51 in a direction indicated by the arrow, thereby applying a physical impact force to agglomerates.

Each of the above disaggregating devices are preferably close to the depositing device for preventing disaggregated and dispersed particles from re-agglomerating together on the way to the depositing device.

FIG. 4 is a schematic diagram of another example of the depositing device. As illustrated in FIG. 4, a depositing device 60 has the same configuration as the configuration of a depositing device that produces a glass preform by using OVD. More particularly, the depositing device 60 includes a reaction chamber 61 that includes an exhaust outlet 61a, a rotating mechanism, which is not illustrate, that supports and rotates a starting material 3, and a multi-tube burner 63 that is used to deposit the silica powder S on the starting material 3. The multi-tube burner 63 is five layered. A center portion, which is the first layer, is connected to the transfer tube P2. The second layer is an argon gas (burner gas G7₁) feed path, the third layer is a hydrogen gas (burner gas G7₂) feed path, the fourth layer is an argon gas (burner gas G7₃) feed path, and the fifth layer is an oxygen gas (burner gas G7₄) feed path. The second, the third, the fourth, and the fifth layers are connected to a gas feed opening 63a to feed the respective burner gases G7₁ to G7₄. The gas feed opening 63a is configured so as to feed the burner gases G7₁ to G7₄ separately to the second, the third, the fourth, and the fifth layers, respectively.

In the depositing device 60, the agglomeration-level-reduced silica-powder-containing carrier gas G2 is fed from the transfer tube P2 to the first layer of the multi-tube burner 63; the burner gases G7₁ to G7₄ is fed to from the gas feed opening 63a the second, the third, the fourth, and the fifth layers respectively. While moving right and left along the longitudinal direction of the rotating starting material 3, the multi-tube burner 63 sprays the silica powder S2 dispersed in the silica-powder-containing carrier gas G2 with a burner flame F2, thereby adhering and depositing the silica powder on the surface of the starting material 3. If the sprayed silica powder is dispersed, mostly, in the form of primary agglomerates or secondary agglomerates, fusion bonding of agglomerates or fusion and densification of an agglomerate occur in a high temperature portion of the burner flame. As a result, giant particles, which have a diameter several orders larger than the diameter of primary particles, are generated. If such giant particles are generated in the burner flame, when the silica powder is deposited on a starting material, problems occur, such as the occurrence of bumps on the deposition surface and a decrease in the flatness of the deposition surface. In contrast, because agglomerates of the silica powder S2 are disaggregated and dispersed by the disaggregating device and the number of agglomerates and the agglomeration level are reduced, the diameter of fumed silica particles of the silica powder S2 fusion bonded in a high temperature portion of the burner flame F2 is also reduced. As a result, deposition of fumed silica particles on the surface of the starting material 3 in the form of giant particles is prevented. Therefore, the occurrence of bumps on the deposition surface and a decrease in the smoothness of the deposition surface are prevented and a porous glass preform 4 that has a smooth deposition surface is produced. Because the carrier gas and the unused silica powder S2 are discharged from the exhaust outlet 61a of the reaction chamber 61 as an exhaust gas G8, the inside of the reaction chamber 61 is maintained in a state appropriate for deposition of the silica powder S2.

### Second Embodiment

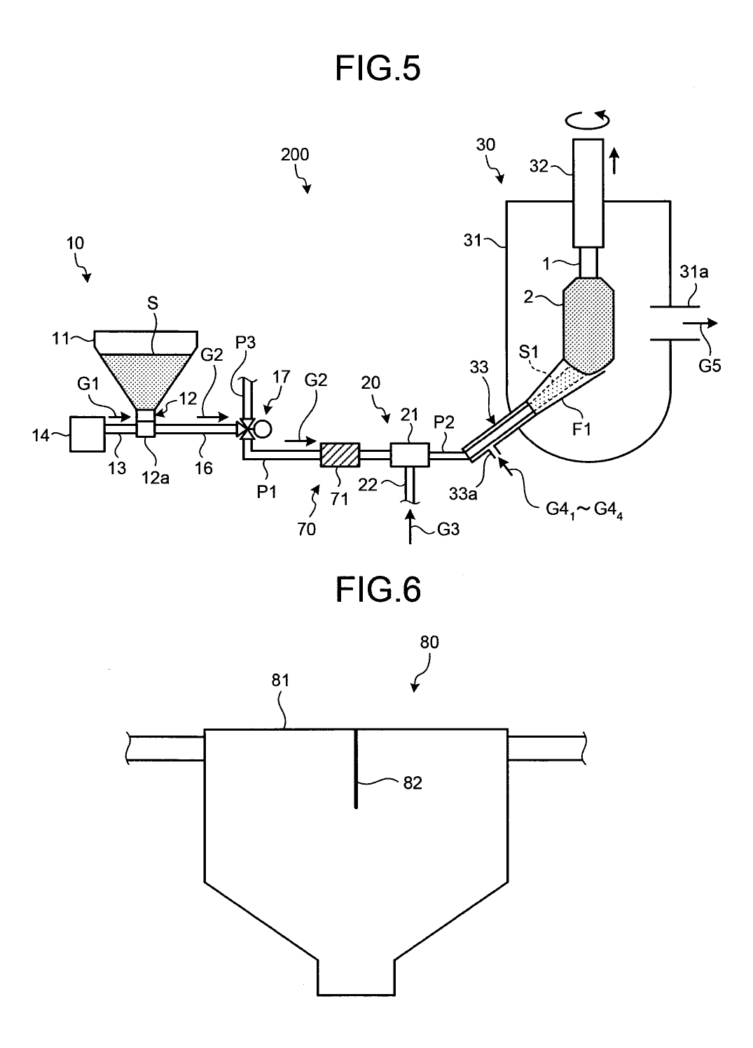

FIG. 5 is a schematic diagram of an apparatus for producing a glass preform according to a second embodiment. As illustrated in FIG. 5, a producing apparatus 200 is made, based on the producing apparatus 100 of the first embodiment illustrated in FIG. 1, by inserting a classifying device 70 to middle of the transfer tube E1 on the transferring device 10-side of the depositing device 30. The classifying device 70 includes a chamber 71.

When a gas passes through the classifying device 70, because of a sharp increase in the volume by presence of the chamber 71, the flow rate of the gas decreases. Therefore, large-diameter particles in the gas settle out to a lower part of the chamber 71. Then, only small-diameter particles that still keep up the gas flow are fed outside.

As described above, by providing the classifying device 70 to upstream of the disaggregating device 20, it is possible to classify agglomerates of the silica powder S contained in the silica-powder-containing carrier gas G2 passing through the transfer tube P1 into large-diameter agglomerates (for example, equal to or greater than 10 μm, about several tens of micrometers) and small-diameter agglomerates (for example, single-digit microns or less). With this configuration, because only small-diameter agglomerates are fed to the disaggregating device 20, the disaggregation level of agglomerates by the disaggregating device 20 is improved.

The classifying device 70 can be inserted to downstream of the disaggregating device 20 on the depositing device 30-side. With this configuration, even if some large-diameter particles are not yet disaggregated sufficiently by the disaggregating device 20 or large-diameter particles are formed in the tube by re-agglomeration, the classifying device 70 can remove them; therefore, it is more likely to prevent feeding of large-diameter particles to the depositing device 20.

The configuration and format of the classifying device is not limited to the above. FIG. 6 is a schematic diagram of another example of the classifying device. A classifying device 80 includes a barrier board 82 inside a chamber 81. The classifying device 80 changes a gas flow drastically by using the barrier board 82, thereby settling large-diameter particles that cannot keep up the gas flow out to a lower part of the chamber for removal. Alternatively, it is allowable to use a cyclone classifier as another example of the classifying device.

It can be said that, from the perspective of ability to separate and transfer small-diameter particles only, these classifying devices have the same function as that of the disaggregating device. Therefore, it is possible to use the classifying devices as substitutes of the disaggregating device.

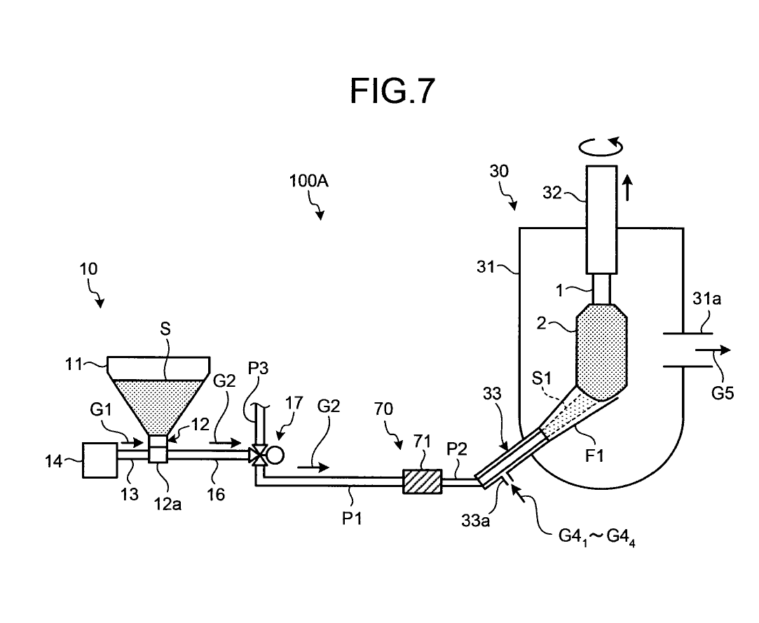

FIG. 7 is a schematic diagram of a configuration that is made, based on the apparatus for producing the glass preform 100 illustrated in FIG. 1, by replacing the disaggregating device 20 with the classifying device 70 illustrated in FIG. 5. A producing apparatus 100A also can produce the glass preform 2 that has the smooth deposition surface in the same manner as in the first embodiment.

It is allowable to move large-diameter particles that are removed by the classifying device back to, for example, the hopper 11 of the transferring device 10. With this configuration, efficient usage of the silica powder S is enabled.

### Example 1

The present embodiment will be explained more specifically below with reference to examples and comparative examples. With Example 1 of the present embodiment, based on the producing method of the configuration illustrated in FIG. 1, by using an apparatus in which the disaggregating device is replaced with the ejector illustrated in FIG. 2 and the depositing device is replaced with the OVD-based device illustrated in FIG. 4, a glass preform is produced.

Fumed silica powder that has an average primary particle diameter of 7 nm is used as silica powder. This silica powder is transferred by using a powder pump. The powder discharge rate is adjusted by the rotation speed of the pump: the silica powder is fed out at the powder discharge rate of 12 g/minute. After that, the discharged silica powder is transferred through the transfer tube with a carrier gas as a silica-powder-containing carrier gas.

One selected from hydrogen, argon, helium, and oxygen is used as an ejector gas of the ejector, which operates as the disaggregating device. The dispersion degree of agglomerates contained in the silica-powder-containing carrier gas is adjusted by the flow rate of the ejector gas fed to the ejector.

In the OVD-based depositing device, the silica-powder-containing carrier gas that also contains the ejector gas is fed to the first layer of the multi-tube burner and then sprayed to a starting material with a flame generated by an hydrogen gas and an oxygen gas that are fed to the third layer and the fifth layer of the multi-tube burner.

As a result, no bumps are formed on the porous glass surface of the produced glass preform and the obtained deposition surface is flat and smooth. The deposition yield, which is calculated by dividing the mass of deposited porous glass by the mass of silica powder fed to the multi-tube burner, is 44% when argon is used as the ejector gas, 53% when helium is used, 82% when oxygen is used, and 85% when hydrogen is used. These results indicate that, from the perspective of the deposition yield, a supporting gas, such as oxygen, or a flammable gas, such as hydrogen, are preferable as the ejector gas and, if an inert gas is used, a gas that has a higher thermal conductivity, such as helium, is preferable. The reason is that fusion bonding to a starting material grows more when the temperature of silica particles is efficiently increased in a burner flame. Due to the same reason, when a supporting gas, a flammable gas, or an inert gas is used as a type of the carrier gas, it is preferable, from the perspective of the deposition yield, to select a gas that has a higher thermal conductivity.

Thereafter, the glass preform, which is made of porous glass deposited on the starting material, is put into a silica-made muffle furnace and a dehydrating/sintering treatment is performed in helium, chlorine gas atmosphere. The generated optical fiber preform is a transparent body with no air bubbles.

Moreover, particles that form the porous body are observed by sampling a part of the glass preform and taking an image through an SEM (scanning electron microscope). It is observed that, although some particles have a particle diameter from about several tens nm to several hundreds nm, most particle groups reflect the size of the primary particle diameter of the material silica powder.

### Example 2

With Example 2 of the present embodiment, based on the producing method of the configuration illustrated in FIG. 5, by using an apparatus in which the dispersing device is replaced with the classifying device that includes the barrier board illustrated in FIG. 6, the disaggregating device is replaced with the ejector illustrated in FIG. 2, and the depositing device is replaced with the OVD-based device illustrated in FIG. 4, a glass preform is produced.

Fumed silica powder that has an average primary particle diameter of 7 nm is used as silica powder. This silica powder is transferred by using a powder pump. The powder discharge rate is adjusted by the rotation speed of the pump: the silica powder is fed out at the powder discharge rate of 12 g/minute. After that, the discharged silica powder is transferred through the transfer tube with a carrier gas as a silica-powder-containing carrier gas.

a mixed gas of oxygen and argon is used as an ejector gas of the ejector, which operates as the disaggregating device. The dispersion degree of agglomerates contained in the silica-powder-containing carrier gas is adjusted by the flow rate of the ejector gas fed to the ejector.

In the OVD-based depositing device, the silica-powder-containing carrier gas that also contains the ejector gas is fed to the first layer of the multi-tube burner and then sprayed to a starting material with a flame generated by an hydrogen gas and an oxygen gas that are fed to the third layer and the fifth layer of the multi-tube burner.

As a result, no bumps are formed on the porous glass surface of the produced glass preform and the obtained deposition surface is flat and smooth.

Thereafter, the glass preform, which is made of porous glass deposited on the starting material, is put into a silica-made muffle furnace and a dehydrating/sintering treatment is performed in helium, chlorine gas atmosphere. The generated optical fiber preform is a transparent body with no air bubbles.

Moreover, particles that form the porous body are observed by sampling a part of the glass preform and taking an image through an SEM. It is observed that most of them are particle groups that reflect the size of the primary particle diameter of the material silica powder, and even large-diameter particles have a diameter about one hundred nm.

### Comparative Example

Next, by using the producing apparatus used in Example 1, a glass preform is produced in almost the same manner as Example 1 except that the ejector, which operates as a disaggregating device, does not operate.

With this case, in the depositing device, many silica particles are observed that come into contact with a starting material but bounce back, without adhering thereto, and then fall down. Many bumps are formed on the porous glass surface of the fabricated optical fiber preform and the deposition surface state is bumpy seriously. The deposition yield of the deposited porous glass is 41%.

Thereafter, in the same manner as in Example 1, the glass preform, which is made of porous glass deposited on the starting material, is put into a silica-made muffle furnace and a dehydrating/sintering treatment is performed in helium, chlorine gas atmosphere. The fabricated glass preform contains closed pores inside and the surface reflects the surface state at the deposition and it is bumpy seriously.

Moreover, particles that form the porous body are observed by sampling a part of the glass preform and taking an image through an SEM. There are observed not only particles that reflect the diameter of primary particles of the material fumed silica powder, i.e., whose diameter is from about several tens nm to several hundreds nm, but also many giant particles whose diameter is in the order of μm or several tens μm. It is assumed that generation of such giant particles causes generation of bumps and a decrease in the flatness of the deposition surface. Therefore, by adjusting the flow rate of the ejector gas in the same manner as in Example 1, agglomerates are preferably disaggregated and dispersed so that the particle diameter decreases to 1 μm or less. Moreover, classification of agglomerates is preferably performed in the same manner as in Example 2.

It is noted that the present invention is not limited to the above embodiments. For example, the burner of the depositing device is allowable to have a mechanism that operates as a disaggregating device. More particularly, for example, it is allowable to add a feed tube to the multi-tube burner 33 of FIG. 1 to feed the disaggregation/dispersion gas G3 to the first layer and disaggregation/dispersion is performed inside the first layer.

Moreover, the disaggregating device can be realized by another mechanism that applies an air flow and a physical impact force. It is allowable to disaggregate and disperse agglomerates by using a centrifugal force generated by a cyclone, etc.

Furthermore, the burner of the depositing device is not limited to a multi-tube burner and can be, for example, a multi-nozzle burner. Moreover, it is allowable to separately arrange a nozzle from which silica powder is sprayed and a burner that generates a flame beside or around the nozzle and heat the silica powder sprayed from the nozzle by a burner flame.

Furthermore, the present disclosure includes ones that are configured by appropriately combining any of the above components.

As described above, a method of producing a glass preform and an apparatus for producing a glass preform according to the present invention is suitably used for producing an optical fiber.

According to the present disclosure, even when silica powder that contains small-diameter particles is used, a glass preform that has a smooth surface can be produced.

What is claimed is:

1. A method of producing a glass perform, the method comprising:
I) transferring a silica powder comprising silica particles;
II) disaggregating and dispersing agglomerates of the silica particles contained in the silica powder while being transferred in (I); and then,
III) depositing the silica powder on a starting material.

2. The method of claim 1, wherein the disaggregating and dispersing employs an air flow.

3. The method of claim 1, wherein the disaggregating and dispersing employs an ejector.

4. The method of claim 3, wherein the disaggregating and dispersing comprises feeding an ejector gas comprising at least one of hydrogen, helium, and oxygen to the ejector.

5. The method of claim 1, wherein the disaggregating and dispersing comprises applying a physical impact force to the silica powder.

6. The method of claim 1, wherein, after the disaggregating and dispersing, the agglomerates have a particle diameter of 1 μm or less.

7. The method of claim 1, wherein the transferring employs a carrier gas comprising at least one of hydrogen, helium, and oxygen.

8. The method of to claim 1, further comprising, before or after (II):
classifying the agglomerates of the silica particles.

9. A method of producing a glass preform, the method comprising:
(I) transferring a silica powder comprising silica particles;
(II) classifying agglomerates of the silica particles contained in the silica powder while being transferred in (I); and then
(III) depositing the silica powder on a starting material.

10. An apparatus for producing a glass preform by depositing silica powder comprising silica particles on a starting material, the apparatus comprising:
a transferring device, which transfers the silica powder;
a disaggregating device connected to the transferring device, which disaggregates and disperses agglomerates of the silica particles contained in the silica powder while being transferred by the transferring device; and
a depositing device connected to the disaggregating device, which deposits the silica powder, which is transferred and obtained by disaggregating and dispersing the agglomerates of the silica particles, on the starting material.

11. The apparatus of claim 10, wherein the disaggregating device applies an air flow to disaggregate and disperse the agglomerates.

12. The apparatus of claim 10, wherein the disaggregating device is an ejector.

13. The apparatus of claim 12, wherein an ejector gas comprising at least one of hydrogen, helium, and oxygen is fed to the ejector.

14. The apparatus of claim 10, wherein the disaggregating device applies a physical impact force to the silica powder.

15. The apparatus of claim 10, wherein the transferring device feeds a carrier gas comprising at least one of hydrogen, helium, and oxygen, and the carrier gas transfers the silica powder.

16. The apparatus of claim 10, further comprising:
a classifying device connected to a transferring device side or a depositing device side of the disaggregating device,
wherein the classifying device classifies the agglomerates of the silica particles.

17. An apparatus for producing a glass preform by depositing silica powder comprising silica particles on a starting material, the apparatus comprising:
a transferring device, which transfers the silica powder;
a classifying device connected to the transferring device, which classifies agglomerates of the silica particles contained in the silica powder while being transferred by the transferring device; and
a depositing device connected to the classifying device, which deposits the silica powder, which is transferred and obtained by classifying the agglomerates of the silica particles, on the starting material.
